(19) United States
(12) Patent Application Publication
(10) Pub. No.: US 2023/0401573 A1
(43) Pub. Date: Dec. 14, 2023

(54) SYSTEMS AND METHODS FOR CONTINUING INTERACTIONS ACROSS MODALITIES AND TECHNOLOGIES

(71) Applicant: JPMORGAN CHASE BANK, N.A., New York, NY (US)

(72) Inventors: Monica LANDER, New York, NY (US); Advait DESHPANDE, Downingtown, PA (US); Rachel MOORE, Pelham, NY (US); Matthew ZARLINO, Dublin, OH (US); Joe RAQUEPAW, Delaware, OH (US)

(21) Appl. No.: 18/334,704

(22) Filed: Jun. 14, 2023

Related U.S. Application Data
(60) Provisional application No. 63/366,345, filed on Jun. 14, 2022.
(60) Provisional application No. 63/366,356, filed on Jun. 14, 2022.

(51) Int. Cl. G06Q 20/38; G06Q 20/40

(52) U.S. Cl. CPC G06Q 20/382; G06Q 20/4016

(57) ABSTRACT

Systems and methods for continuing interactions across modalities and technologies are disclosed. A method may include: a computer program executed by a backend electronic device receiving, from an in-person digital assistant, identifying information for a customer that is interacting with the in-person digital assistant on a first electronic device; identifying the customer using the identifying information received from the in-person digital assistant; receiving a state of the interaction for the interaction from the in-person digital assistant device and saving the state of the interaction; receiving, from a metaverse digital assistant executed by a second electronic device, the identifying information; identifying the customer using the identifying information; retrieving the saved state of the interaction; and communicating the saved state of the interaction to the metaverse digital assistant. The second electronic device may continue the interaction with the customer using the saved state of interaction.

### RELATED APPLICATIONS

This application claims priority to, and the benefit of, U.S. Provisional Patent Application Ser. No. 63/366,345 and U.S. Provisional Patent Application Ser. No. 63/366,356, both filed Jun. 14, 2022, the disclosure of each of which is hereby incorporated, by reference, in its entirety.

### BACKGROUND OF THE INVENTION

### 1. Field of the Invention

Embodiments relate to systems and methods for continuing interactions across modalities and technologies.

### 2. Description of the Related Art

Today, customers can pre-stage an interaction using their electronic devices. For example, in the banking field, a customer may pre-stage a transfer of funds from one account to another that requires the customer to be present to execute the transaction. Despite this, the customer is often required to repeat much of the process when the customer arrives at the physical location.

### SUMMARY OF THE INVENTION

Systems and methods for continuing interactions across modalities and technologies are disclosed. In one embodiment, a method for continuing interactions across modalities and technologies may include: (1) receiving, by a computer program executed by a backend electronic device and from an in-person digital assistant, identifying information for a customer that is interacting with the in-person digital assistant on a first electronic device; (2) identifying, by the computer program, the customer using the identifying information received from the in-person digital assistant; (3) receiving, by the computer program, a state of the interaction for the interaction from the in-person digital assistant device and saving the state of the interaction; (4) receiving, by the computer program and from a metaverse digital assistant executed by a second electronic device, the identifying information; (5) identifying, by the computer program, the customer using the identifying information; (6) retrieving, by the computer program, the saved state of the interaction; and (7) communicating, by the computer program, the saved state of the interaction to the metaverse digital assistant. The second electronic device may be configured to continue the interaction with the customer using the saved state of interaction.

In one embodiment, the state of the interaction may include an authentication status of the customer and an identification of a transaction being conducted.

In one embodiment, the method may also include authenticating, by the computer program, the customer using the identifying information received from the in-person digital assistant; and authenticating, by the computer program, the customer using the identifying information received from the metaverse digital assistant.

In one embodiment, the in-person digital assistant may include a digital person, a chat interface, or a voice response interface.

In one embodiment, the first electronic device may include a mobile electronic device.

In one embodiment, the second electronic device continues the interaction in a metaverse/web 3.0 environment.

In one embodiment, the method may also include applying, by the computer program, a risk rule to the interaction before communicating the saved state of the interaction to the metaverse digital assistant.

In one embodiment, the in-person digital assistant and the metaverse digital assistant are of the same form.

According to another embodiment, a system may include: a first electronic device executing an in-person digital assistant; a second electronic device executing a metaverse digital assistant; and a backend electronic device executing a computer program. The in-person digital assistant receives an interaction from a customer, receives identifying information from the customer, and provides the identifying information to the computer program. The computer program identifies the customer using the identifying information and receives a state of the interaction for the interaction from the in-person digital assistant and saves the state of the interaction. The metaverse digital assistant receives the identifying information from the customer and provides the identifying information to the computer program on a backend electronic device. The computer program identifies the customer using the identifying information, retrieves the saved state of the interaction, and communicates the saved state of the interaction to the metaverse digital assistant. The second electronic device continues the interaction with the customer.

In one embodiment, the state of the interaction may include an authentication status of the customer and an identification of a transaction being conducted.

In one embodiment, the computer program authenticates the customer using the identifying information received from the in-person digital assistant and authenticates the customer using the identifying information received from the metaverse digital assistant.

In one embodiment, the in-person digital assistant may include a digital person, a chat interface, or a voice response interface.

In one embodiment, the first electronic device may include a mobile electronic device.

In one embodiment, the second electronic device continues the interaction in a metaverse/web 3.0 environment.

In one embodiment, the computer program applies a risk rule to the interaction before communicating the saved state of the interaction to the metaverse digital assistant.

In one embodiment, the in-person digital assistant and the metaverse digital assistant are of the same form.

According to another embodiment, a non-transitory computer readable storage medium, may include instructions stored thereon, which when read and executed by one or more computer processors, cause the one or more computer processors to perform steps comprising: receiving, from an in-person digital assistant, identifying information for a customer that is interacting with the in-person digital assistant on a first electronic device; identifying the customer using the identifying information received from the in-person digital assistant; receiving a state of the interaction for the interaction from the in-person digital assistant device and saving the state of the interaction; receiving, from a metaverse digital assistant executed by a second electronic device, the identifying information; identifying the customer using the identifying information received from the metaverse digital assistant; retrieving the saved state of the interaction; and communicating the saved state of the interaction to the metaverse digital assistant. The second electronic device continues the interaction with the customer in a metaverse/web 3.0 environment.

In one embodiment, the state of the interaction may include an authentication status of the customer and an identification of a transaction being conducted.

In one embodiment, the in-person digital assistant may include a digital person, a chat interface, or a voice response interface.

In one embodiment, the non-transitory computer readable storage medium may also include instructions stored thereon, which when read and executed by one or more computer processors, cause the one or more computer processors to apply a risk rule to the interaction before communicating the saved state of the interaction to the metaverse digital assistant.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for continuing interactions across modalities and technologies according to one embodiment;

FIG. 2 depicts a method for continuing interactions across modalities and technologies according to one embodiment;

FIG. 3 depicts an exemplary computing system for implementing aspects of the present disclosure.

### DETAILED DESCRIPTION OF PREFERRED EMBODIMENTS

Embodiments are directed to systems and methods for continuing interactions across modalities and technologies.

Embodiments may provide a multi-modality experience by plugging into the same platform and system of record, and extending the interaction across modalities and technologies, by being aware of the context and authentication of the customer interaction. Embodiments may provide seamless customer interactions across different modalities and technologies/devices without losing the context or state of the interaction. The state of the interaction may be carried to the next device/modality and authentication session.

Embodiments may leverage biometric authentication to re-affirm a customer's identity if required.

In embodiments, a digital assistant on the user's electronic device and an electronic device at the physical location may render an avatar (e.g., a digital person, hologram, etc.) that can then greet and authenticate the customer. The electronic device at the physical location may be a tablet, kiosk, etc. In another embodiment, the digital assistant may provide a conversational interaction with the user.

In embodiments, the customer may provide personal identifiable information (PII) or sensitive transaction information in private to the digital assistant, so that the customers requiring authentication in person do not have to repeat that PII or sensitive information in a public or non-private setting.

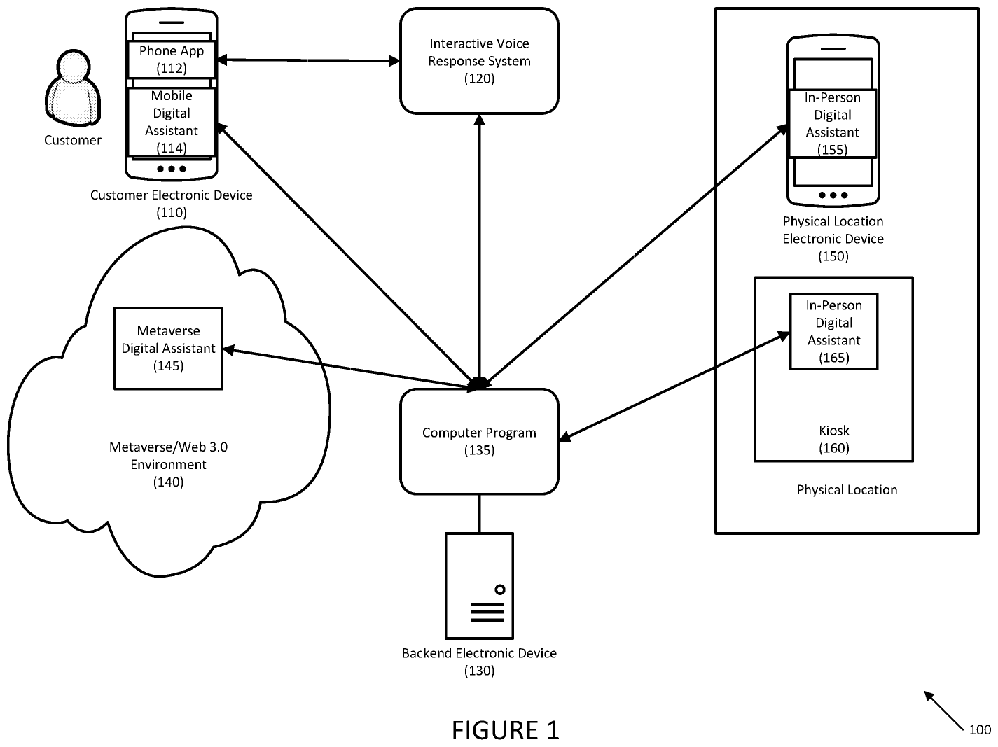

Referring to FIG. 1, a system for continuing interactions across modalities and technologies is disclosed according to an embodiment. System 100 may include customer electronic device 110, such as computers (e.g., workstation, desktop, laptop, tablet, etc.), smart/mobile devices (e.g., smart phones, smart watches, etc.), home assistants, Internet of Things (IoT) appliances, etc. that may execute one or more computer programs or applications, such as phone application 112, mobile digital assistant 114, etc. Customer electronic device 110 may also execute other computer programs or applications, such as a browser (not shown), chat application (not shown), voice interaction application (not shown), etc. with which the customer may interact.

Phone application 112 may interface with interactive voice response system (IVR) 120 by which the customer may conduct an interaction. For example, the customer may conduct a voice-based interaction (e.g., voice recognition), a menu-driven interaction, etc.

IVR system 120 may interface with computer program 135 executed by backend electronic device 130 for an organization, such as a financial institution. Backend electronic device 130 may be a server (e.g., physical and/or cloud-based) or similar, a computer, etc. Computer program 135 may identify the customer using a customer data entry, such as an account number, social security number, or any other unique identifier, or using biometrics (e.g., voice biometrics). Computer program 135 may also authenticate the customer using customer data entry (e.g., a personal identification number, an out-of-wallet question, etc.), or using biometrics (e.g., voice biometrics).

IVR system 120 may communicate session information (e.g., the state of the interaction with the customer) to computer program 135. Computer program 135 may then save the state of the interaction.

The state of the interaction may include, for example, an authentication status, an identification of what the customer was doing (e.g., an identification of a transaction being conducted), with whom the customer was interacting, the customer location, the present/current channel of interaction the customer is using, etc.

The customer may also conduct a voice-based interaction (e.g., voice recognition) or a text-based interaction with mobile digital assistant 114. Mobile digital assistant 114 may provide a digital person, hologram, a chat interface, a menu, a voice response interface, etc. with which the customer may interact. Mobile digital assistant 114 may communicate with computer program 135, which may identify the customer using customer data entry, such as an account number, social security number, or any other unique identifier, or using biometrics (e.g., voice biometrics, facial biometrics, palm, etc.).

Mobile digital assistant 114 may provide a voice assistant and may provide voice technologies that may be used in immersive realities, such as the Metaverse, Web3.0, or any spatial computing environment.

Computer program 135 may also authenticate the customer using customer data entry (e.g., a personal identification number, out-of-wallet questions, etc.), or using biometrics (e.g., voice biometrics, facial biometrics, palm, etc.).

Mobile digital assistant 114 may communicate session information (e.g., the state of the interaction with the customer) to computer program 135. Computer program 135 may save the state of the interaction.

The customer may also conduct a voice-based interaction (e.g., voice recognition) or a text-based interaction with metaverse digital assistant 145 in metaverse/web 3.0 environment 140. Metaverse digital assistant 145 may provide a virtual human, a chat interface, a menu, a voice response interface, etc. with which the customer may interact. Metaverse digital assistant 145 may communicate with computer program 135, which may identify the customer using customer data entry, such as an account number, social security number, or any other unique identifier, biometrics (e.g., voice biometrics, facial biometrics, palm, etc.).

In one embodiment, metaverse/web 3.0 environment 140 may be accessed using customer electronic device 110, physical location electronic device 150, kiosk 160, or a different electronic device. Metaverse/web 3.0 environment 140 may provide a spatial computing environment for the user.

Computer program 135 may also authenticate the customer using customer data entry (e.g., a personal identification number, an out-of-wallet question, etc.), biometrics (e.g., voice biometrics, facial biometrics, finger, palm, etc.).

Metaverse digital assistant 145 may communicate session information (e.g., the state of the interaction with the customer) to computer program 135. Computer program 135 may save the state of the interaction.

The customer may conduct an in-person interaction at a physical location with, for example, physical location electronic device 150, kiosk 160, etc. Physical location electronic device 150 or kiosk 160 may execute in-person digital assistant 155 or 165. In-person digital assistant 155 or 165 may provide a digital person, hologram, a chat interface, a menu, a voice response interface, etc. with which the customer may interact. In-person digital assistant 155 or 165 may communicate with computer program 135, which may identify the customer using customer data entry, such as an account number, social security number, or any other unique identifier, or using biometrics (e.g., voice biometrics, facial biometrics, etc.).

Computer program 135 may also authenticate the customer using customer data entry (e.g., a personal identification number, an out-of-wallet question, etc.), or using biometrics (e.g., voice biometrics, facial biometrics, palm, etc.).

In-person digital assistant 155 or 165 may communicate session information (e.g., the state of the interaction with the customer) to the computer program. Computer program 135 may save the state of the interaction.

Computer program 135 may save the state of the interaction from any device so that the interaction may continue on another device. For example, the customer may start an interaction using mobile digital assistant 114, and then continue the interaction using in-person digital assistant 155 or 165. In-person digital assistant 155 or 165 may identify the customer using, for example, the customer's biometrics (e.g., voice biometrics, facial biometrics, palm, etc.) and may then retrieve the state of the interaction.

In one embodiment, computer program 135 may associate the state of the interaction with the customer.

In one embodiment, computer program 135 may implement certain risk rules before allowing the interaction to continue. For example, computer program 135 may prevent “impossible travel” where a customer is prevented from continuing an interaction initiated on customer electronic device 110 at a physical location if, based on the location of customer electronic device 110, indicates that it would be impossible for the customer to be at a physical location (e.g., customer electronic device 110 indicates that the customer is in California and within five minutes the customer attempts to continue an interaction from in-person digital assistant 155 or 165 at a physical location in New York).

Other risk and/or fraud prevention methodologies may be used as is necessary and/or desired.

In one embodiment, the authentication from the first interaction may be applied to the second interaction. For example, if the customer is authenticated using mobile digital assistant 114, the authentication may be communicated to in-person digital assistant 155 or 165 so that no or lesser authentication may be required. For example, the customer may be provided with a machine-readable code (e.g., QR code) to continue the session with in-person digital assistant 155 or 165, which may function as some or all of the authentication required by in-person digital assistant 155 or 165.

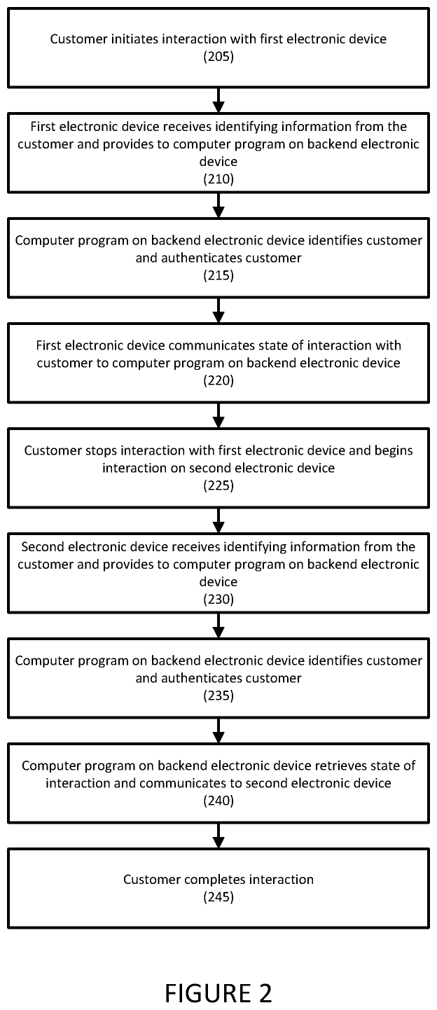

Referring to FIG. 2, a system for continuing interactions across modalities and technologies is disclosed according to an embodiment.

In step 205, a customer may initiate an interaction with a first electronic device. The interaction may be to conduct a transaction, for example.

The first electronic device may be a customer electronic device (e.g., a mobile electronic device, a computer, a smart device, a home assistant, an IoT device, etc.), an electronic device at a physical location (e.g., a kiosk, tablet, terminal, etc.), in the metaverse or other web 3.0 interface, etc. and the interaction may involve a voice response interface, a digital assistant, etc. For example, the electronic device may execute an in-person digital assistant that may provide a virtual human, a chat interface, a menu, a voice response interface, etc. with which the customer may interact.

In step 210, the first electronic device may receive identifying information from the customer and may provide the identifying information to a computer program executed by a backend electronic device, such as a server (e.g., physical and/or cloud-based, etc.), computer, etc. The identifying information may include customer data entry, such as an account number, social security number, or any other unique identifier, or biometrics (e.g., voice biometrics, facial biometrics, etc.).

In step 215, the computer program on the backend electronic device may identify and authenticate the customer. For example, the computer program may access a database of customer information and may use the identifying information to identify the customer.

The computer program may also authenticate the customer using customer data entry (e.g., a personal identification number, an out-of-wallet question, etc.), or using biometrics (e.g., voice biometrics, facial biometrics, palm, etc.).

In step 220, as the customer interacts with the first electronic device, the first electronic device may communicate a state of the interaction with the customer to the computer program on the backend electronic device. The computer program on the backend electronic device may save the state of the interaction as needed, and may associate the state of the interaction with the customer.

In step 225, the customer may stop the interaction with the first electronic device and may begin an interaction on a second electronic device. The second electronic device may be the same type of electronic device as the first electronic device, or it may be different.

For example, the first electronic device may be the customer's mobile electronic device, and the second electronic device may be an in-person electronic device at a physical location.

In step 230, the second electronic device may receive identifying information from the customer and may provide the identifying information to the computer program on the backend electronic device. This may be similar to step 210, above.

In step 235, the computer program on backend electronic device may identify and authenticate the customer. For example, the computer program may access a database of customer information and may use the identifying information to identify the customer.

The computer program may also authenticate the customer using customer data entry (e.g., a personal identification number, an out-of-wallet question, etc.), or biometrics (e.g., voice biometrics, facial biometrics, palm, etc.).

In one embodiment, the authentication may be a lesser authentication than the authentication with the customer first interacting with the first electronic device. In addition, the customer may present a machine-readable code (e.g., a QR code) or similar to the second electronic device as part of the authentication process.

In step 240, once identified and authenticated, the computer program on the backend electronic device may retrieve the saved state of the interaction associated with the customer and may communicate the state of the interaction to the second electronic device. The customer may then continue the interaction that was initiated on the first electronic device with the second electronic device.

In one embodiment, if the customer was interacting with an avatar as the digital assistant (e.g., an artificial intelligence human being), the same avatar may be presented on the second electronic device.

In one embodiment, before communicating the state of the interaction to the second electronic device, the computer program on the backend electronic device may implement certain risk rules. For example, the computer program on the backend electronic device may apply risk rules to “impossible travel,” to prevent fraud, to prevent unauthorized disclosure of PII, etc.

In step 245, the customer may complete the interaction, and the session may be terminated.

An exemplary use case is as follows. A customer may enter the metaverse or web 3.0 environment and may visit an entity's virtual branch or virtual asset, such as a bank's virtual ATM. The customer may interact with a digital person, such as an avatar, and may request and receive information about the bank's products or services.

The information may be presented visually (e.g., graphics and/or text) and/or by audio. For example, charts, comparison tables, product images, etc. may be provided, and the customer may interact with the graphics to customize the products as is necessary and/or desired.

While interacting with the digital person, the customer may complete an actual application and open an account, individually or with a co-applicant. The co-applicant need not be physically present with the customer; the co-applicant may be present with the customer in the metaverse or web 3.0 environment.

In one embodiment, the customer may initiate the application in the metaverse or web 3.0 environment, and may then continue the application outside of the metaverse or web 3.0 environment using, for example, the customer electronic device and the entity's web site or application, a physical location electronic device or kiosk, etc. As another example, a customer may start a joint application with a co-applicant at a physical location, and then complete the application with the co-applicant present in the metaverse or web 3.0 environment. An example of such multi-modality interaction is disclosed in U.S. Provisional Patent Application Ser. No. 63/366,345, the disclosure of which is hereby incorporated, by reference, in its entirety.

The customer may also submit information for services that may be provided, such as bank services. For example, the customer may update account information, stop payment on a check, receive banking statements, update a PIN, activate or de-activate account restrictions (e.g., spending limits, geographical limits, etc.), portfolio analysis, etc.

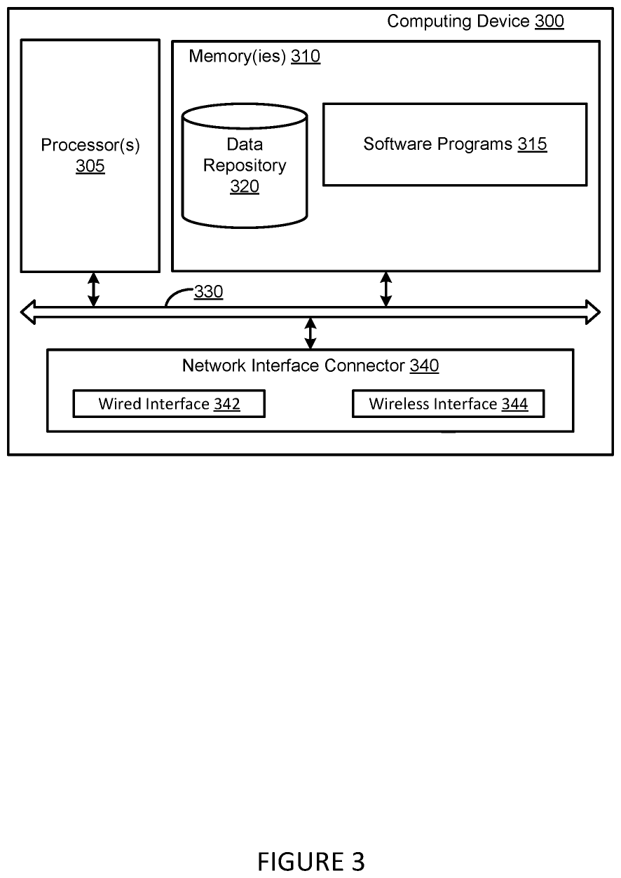

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for continuing interactions across modalities and technologies, comprising:
receiving, by a computer program executed by a backend electronic device and from an in-person digital assistant, identifying information for a customer that is interacting with the in-person digital assistant on a first electronic device;
identifying, by the computer program, the customer using the identifying information received from the in-person digital assistant;
receiving, by the computer program, a state of the interaction for the interaction from the in-person digital assistant device and saving the state of the interaction;
receiving, by the computer program and from a metaverse digital assistant executed by a second electronic device, the identifying information;
identifying, by the computer program, the customer using the identifying information;
retrieving, by the computer program, the saved state of the interaction; and
communicating, by the computer program, the saved state of the interaction to the metaverse digital assistant;
wherein the second electronic device is configured to continue the interaction with the customer using the saved state of interaction.

2. The method of claim 1, wherein the state of the interaction comprises an authentication status of the customer and an identification of a transaction being conducted.

3. The method of claim 1, further comprising:
authenticating, by the computer program, the customer using the identifying information received from the in-person digital assistant; and
authenticating, by the computer program, the customer using the identifying information received from the metaverse digital assistant.

4. The method of claim 1, wherein the in-person digital assistant comprises a digital person, a chat interface, or a voice response interface.

5. The method of claim 1, wherein the first electronic device comprises a mobile electronic device.

6. The method of claim 1, wherein the second electronic device continues the interaction in a metaverse/web 3.0 environment.

7. The method of claim 1, further comprising:
applying, by the computer program, a risk rule to the interaction before communicating the saved state of the interaction to the metaverse digital assistant.

8. The method of claim 1, wherein the in-person digital assistant and the metaverse digital assistant are of the same form.

9. A system, comprising:
a first electronic device executing an in-person digital assistant;
a second electronic device executing a metaverse digital assistant; and
a backend electronic device executing a computer program;
wherein:
the in-person digital assistant receives an interaction from a customer;
the in-person digital assistant receives identifying information from the customer;
the in-person digital assistant provides the identifying information to the computer program;
the computer program identifies the customer using the identifying information;
the computer program receives a state of the interaction for the interaction from the in-person digital assistant and saves the state of the interaction;
the metaverse digital assistant receives the identifying information from the customer;
the metaverse digital assistant provides the identifying information to the computer program on a backend electronic device;
the computer program identifies the customer using the identifying information;
the computer program on the backend electronic device retrieves the saved state of the interaction;
the computer program on the backend electronic device communicates the saved state of the interaction to the metaverse digital assistant; and
the second electronic device continues the interaction with the customer.

10. The system of claim 9, wherein the state of the interaction comprises an authentication status of the customer and an identification of a transaction being conducted.

11. The system of claim 9, wherein the computer program authenticates the customer using the identifying information received from the in-person digital assistant and authenticates the customer using the identifying information received from the metaverse digital assistant.

12. The system of claim 9, wherein the in-person digital assistant comprises a digital person, a chat interface, or a voice response interface.

13. The system of claim 9, wherein the first electronic device comprises a mobile electronic device.

14. The system of claim 9, wherein the second electronic device continues the interaction in a metaverse/web 3.0 environment.

15. The system of claim 9, wherein the computer program applies a risk rule to the interaction before communicating the saved state of the interaction to the metaverse digital assistant.

16. The system of claim 9, wherein the in-person digital assistant and the metaverse digital assistant are of the same form.

17. A non-transitory computer readable storage medium, including instructions stored thereon, which when read and executed by one or more computer processors, cause the one or more computer processors to perform steps comprising:
receiving, from an in-person digital assistant, identifying information for a customer that is interacting with the in-person digital assistant on a first electronic device;
identifying the customer using the identifying information received from the in-person digital assistant;
receiving a state of the interaction for the interaction from the in-person digital assistant device and saving the state of the interaction;
receiving, from a metaverse digital assistant executed by a second electronic device, the identifying information;
identifying the customer using the identifying information received from the metaverse digital assistant;
retrieving the saved state of the interaction; and
communicating the saved state of the interaction to the metaverse digital assistant;
wherein the second electronic device continues the interaction with the customer in a metaverse/web 3.0 environment.

18. The non-transitory computer readable storage medium of claim 17, wherein the state of the interaction comprises an authentication status of the customer and an identification of a transaction being conducted.

19. The non-transitory computer readable storage medium of claim 17, wherein the in-person digital assistant comprises a digital person, a chat interface, or a voice response interface.

20. The non-transitory computer readable storage medium of claim 17, further including instructions stored thereon, which when read and executed by one or more computer processors, cause the one or more computer processors to apply a risk rule to the interaction before communicating the saved state of the interaction to the metaverse digital assistant.
